(19) United States
(12) Patent Application Publication
(10) Pub. No.: US 2005/0280351 A1
(43) Pub. Date: Dec. 22, 2005

(54) Field emission display (FED) and method of manufacture thereof

(76) Inventors: Byong-Gwon Song, Seoul (KR); Moon-Jin Shin, Yongin-si (KR)

Correspondence Address: Robert E. Bushnell;Attorney-at-Law, Suite 300, 1522 "K" Street, N.W., Washington, DC, 20005-1202, US

(21) Appl. No.: 11/151,194

(22) Filed: Jun. 14, 2005

(30) Foreign Application Priority Data
Jun. 17, 2004 (KR) 10-2004-0045045

(51) Int. Cl. H01J 1/30

(52) U.S. Cl. 313/497; 313/495

(57) ABSTRACT

A Field Emission Display (FED) includes: an anode plate having an anode electrode and a fluorescent layer arranged therein; a cathode plate having an electron emission source and a gate electrode arranged therein, the electron emission source facing the fluorescent layer and adapted to emit electrons and the gate electrode having a gate hole adapted to pass the electrons therethrough; a mesh grid arranged within the cathode plate, the mesh grid having an electron beam control hole corresponding to the gate hole and having a photosensitive adhesion layer on a surface facing the cathode plate; and a spacer provided between the anode plate and the mesh grid and adapted to closely adhere the mesh grid to the cathode plate by a negative pressure between the anode plate and the cathode plate.

### CLAIM OF PRIORITY

This application makes reference to, incorporates the same herein, and claims all benefits accruing under 35 U.S.C. §119 from an application earlier filed in the Korean Intellectual Property Office on 17 Jun. 2004 and there duly assigned Serial No. 10-2004-0045045.

### BACKGROUND OF THE INVENTION

1. Field of the Invention

The present invention relates to a Field Emission Display (FED) having a metal mesh grid and a method of manufacturing the FED.

2. Description of Related Art

When electrons are emitted from an internal electron emission source of a Field Emission Display (FED), arcing occurs occasionally in an internal vacuum space between a cathode plate in which an electron emission source is provided and an anode plate which has a fluorescent layer that the electrons collide with. It is assumed that such an arcing occurs due to a discharge resulting from transient gaseous ionization (an avalanche phenomena) caused by outgassing. In addition, arcing may occur when an anode voltage of 1 KV or more is supplied for chamber testing in a Field Emission Array (FEA) formed on the cathode plate, or for testing of the FED after combining the cathode plate and the anode plate. When a surface of the FEA in which the arcing occurred is carefully inspected using an optical microscope, it can be seen that damage caused by the arcing occurs mainly in a gate edge. This is presumably because the gate edge is sharp and the arcing can thus occur under a high electric field. The arcing causes a short circuit between an anode where a highest anode voltage is supplied and a gate electrode where a lower gate voltage is supplied. Accordingly, the anode voltage is supplied to the gate electrode, and this high voltage causes damage to a gate oxide electrically insulating the cathode electrode from the gate electrode, and a resistive layer formed on the cathode electrode. This phenomenon becomes more serious as the anode voltage increases. As a result, since the arcing can occur when supplying an anode voltage of 1 KV or more, it is very difficult to manufacture a FED with a high brightness operating normally at high voltages from a simple FED structure where a cathode and an anode are separated from each other by a spacer.

Since this simple FED has a structure where electrons extracted by a gate electrode are accelerated toward a fluorescent layer, there is a problem in that the electrons diverge and collide against an area other than a given pixel area of the fluorescent layer. This problem can be solved by adding an additional electrode which focuses the electron beam onto a given pixel on the fluorescent layer. This electrode corresponds to a second gate electrode in the FED, and is typically integrally formed unlike the gate electrode which is provided as a stripe form. The second gate electrode not only controls the electron beam but also prevents arcing from occurring in the FED.

Korean Patent Publication No. 2001-81496 and U.S. Pat. No. 5,710,483 discuss a double-gate FED equipped with the aforementioned second gate electrode.

The FED of U.S. Pat. No. 5,710,483 has a second gate electrode formed by depositing a metal, and the FED of Korean Patent Publication No. 2001-81496 has a second gate electrode formed of an additional metal mesh which is separated from anode and cathode electrodes by a spacer.

As described in U.S. Pat. No. 5,710,483, a size of the second gate electrode formed by depositing a metal is limited by a size of the deposition equipment, whereby the FED cannot exceed a predetermined size. Accordingly, this is not suitable for manufacturing a large-sized FED since metal film deposition equipment for manufacturing a large-sized FED must be newly manufactured at a huge cost. In addition, since the thickness of the second gate electrode formed by depositing a metal is limited to about 1.5 micron or less, it is difficult to obtain a sufficient thickness to effectively control an electron beam.

In the FED of Korean Patent Publication No. 2001-81496, the second gate electrode (mesh grid) is fabricated from a metal plate. Accordingly, it is possible to freely select the thickness of the second gate electrode without the aforementioned limitation, whereby an electron beam can be efficiently controlled.

In an FED having a mesh grid employed as a second gate electrode, a cathode plate and an anode plate are separated from each other by a spacer. A space between the cathode plate and the anode plate is under vacuum and thus the cathode plate and the anode plate are firmly held together by an internal negative pressure with a lower spacer and an upper spacer interposed therebetween.

In the cathode plate, a cathode electrode is formed on a rear panel and a gate insulation layer is formed on the cathode electrode. A thru-hole is formed in the gate insulation layer and the cathode electrode is exposed via the thru-hole. An electron emission source is formed on the cathode electrode exposed via the thru-hole. A gate electrode is formed on the gate insulation layer. The gate electrode has a gate hole corresponding to the thru-hole.

In the anode plate, an anode electrode is formed inside of a front panel. A fluorescent layer is formed on a portion of the anode electrode facing the gate hole. A black matrix can be formed on the rest of the anode electrode.

A mesh grid is provided between the cathode plate and the anode plate, the mesh grid being separated from the cathode plate and the anode plate and supported by the lower spacer and the upper spacer. The mesh grid has an electron beam control hole corresponding to the gate hole.

In such an FED, a method of combining a spacer is as follows.

First, an insulation layer (the lower spacer) is formed on one side of the mesh grid, a frit paste is printed on the insulation layer, and a portion of the insulation layer covered with the frit paste is arranged to contact the gate insulation layer. Subsequently, the frit paste is sintered for a predetermined period of time.

Subsequently, the anode plate with the upper spacer attached in a typical manner is aligned with the cathode plate having the mesh grid thereon, and then vacuum-packaged.

According to this method, firing of the frit paste at a high temperature of about 430° C. takes about 4 to 8 hours including a temperature rising time and cooling time, and a difference in thermal expansion between the metal mesh grid and the cathode plate may cause a misalignment therebetween. In addition, a high temperature may create a deformation of the mesh grid. In addition, a deterioration of the exposed electron emission source may impair an electron emission effect.

Furthermore, the frit paste can flow into a lateral side of the electron beam control hole of the mesh grid, whereby arcing may occur in driving the FED.

The deformation of the mesh grid results in a deterioration of the performance of the FED. Therefore, a new method to overcome this problem is required.

### SUMMARY OF THE INVENTION

The present invention provides a FED and a method of manufacture thereof in which a mesh grid is fixed to a cathode plate at low temperatures.

According to one aspect of the present invention, a Field Emission Display (FED) is provided comprising: an anode plate having an anode electrode and a fluorescent layer arranged therein; a cathode plate having an electron emission source and a gate electrode arranged therein, the electron emission source facing the fluorescent layer and adapted to emit electrons and the gate electrode having a gate hole adapted to pass the electrons therethrough; a mesh grid arranged within the cathode plate, the mesh grid having an electron beam control hole corresponding to the gate hole and having a photosensitive adhesion layer on a surface facing the cathode plate; and a spacer provided between the anode plate and the mesh grid and adapted to closely adhere the mesh grid to the cathode plate by a negative pressure between the anode plate and the cathode plate.

The mesh grid preferably further comprises an insulation layer arranged between the surface facing the cathode plate and the photosensitive adhesion layer.

The photosensitive adhesion layer comprises a photosensitive polyimide layer.

According to another aspect of the present invention, a method of manufacturing a Field Emission Display (FED) is provided, the method comprising: forming an anode plate having an anode electrode and a fluorescent layer arranged therein; forming a cathode plate having an electron emission source and a gate electrode arranged therein, the electron emission source facing the fluorescent layer and adapted to emit electrons and the gate electrode having a gate hole adapted to pass the electrons therethrough; forming an additional mesh grid having an electron beam control hole corresponding to the gate hole and having an insulation layer and an adhesion layer sequentially stacked on a first surface facing the cathode plate; combining the mesh grid and the cathode plate so that the adhesion layer of the mesh grid faces the cathode plate; and combining and vacuum-sealing the anode plate and the cathode plate with a spacer interposed between the cathode plate and the anode plate.

The insulation layer of the mesh grid preferably comprises SiO₂.

Forming the mesh grid preferably comprises: forming a metal plate having an electron beam control hole therein; forming an insulation layer having a hole corresponding to the electron beam control hole; forming a photosensitive adhesion layer on the insulation layer; exposing the photosensitive adhesion layer from a second surface of the metal plate; and removing the exposed photosensitive adhesion layer.

The photosensitive adhesion layer preferably comprises a photosensitive polyimide.

The photosensitive adhesion layer is preferably formed by a method selected from the group consisting of a spin coating method, a screen printing method, and a roller printing method.

Combining and vacuum-sealing preferably comprises curing at a temperature of 150˜300° C.

According to still another aspect of the present invention, a method of manufacturing a Field Emission Display (FED) is provided, the method comprising: forming an anode plate having an anode electrode and a fluorescent layer arranged therein; forming a cathode plate having an electron emission source and a gate electrode arranged therein, the electron emission source facing the fluorescent layer and adapted to emit electrons and the gate electrode having a gate hole adapted to pass the electrons therethrough; forming an additional mesh grid having an electron beam control hole corresponding to the gate hole; forming a photosensitive adhesion layer covering the gate electrode on the cathode plate; arranging the mesh grid on the adhesion layer; exposing the adhesion layer from above the cathode plate; removing the exposed adhesion layer; and combining and vacuum-sealing the anode plate and the cathode plate with a spacer interposed between the cathode plate and the anode plate.

The photosensitive adhesion layer preferably comprises a photosensitive polyimide.

The photosensitive adhesion layer is preferably formed by a method selected from the group consisting of a spin coating method, a screen printing method, and a roller printing method.

Forming the additional mesh grid preferably comprises forming an insulation layer having a hole corresponding to the electron beam control hole on one side of the mesh grid; and arranging the mesh grid preferably comprises contacting the insulation layer on the mesh grid with the adhesion layer.

Forming the photosensitive adhesion layer preferably comprises soft-baking the adhesion layer.

Arranging the mesh grid preferably comprises soft-baking the adhesion layer.

Combining and vacuum-sealing the anode plate and the cathode plate preferably comprises curing at a temperature of 150˜300° C.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a sectional view of an FED;

FIG. 2 is a sectional view of an FED according to an embodiment of the present invention;

FIGS. 3A and 3B are sectional views of a method of manufacturing an anode plate;

FIG. 4 is a sectional view of a method of manufacturing a cathode plate;

FIGS. 5A to 5E are views of a method of providing a mesh grid according to an embodiment of the present invention;

FIG. 6 is a sectional view of a mesh grid attached inside of a cathode plate;

FIG. 7 is a view a method of combining an anode plate and a cathode plate; and

FIGS. 8A to 8C are views of a method of attaching a mesh grid to a cathode plate according to another embodiment of the present invention.

### DETAILED DESCRIPTION OF THE INVENTION

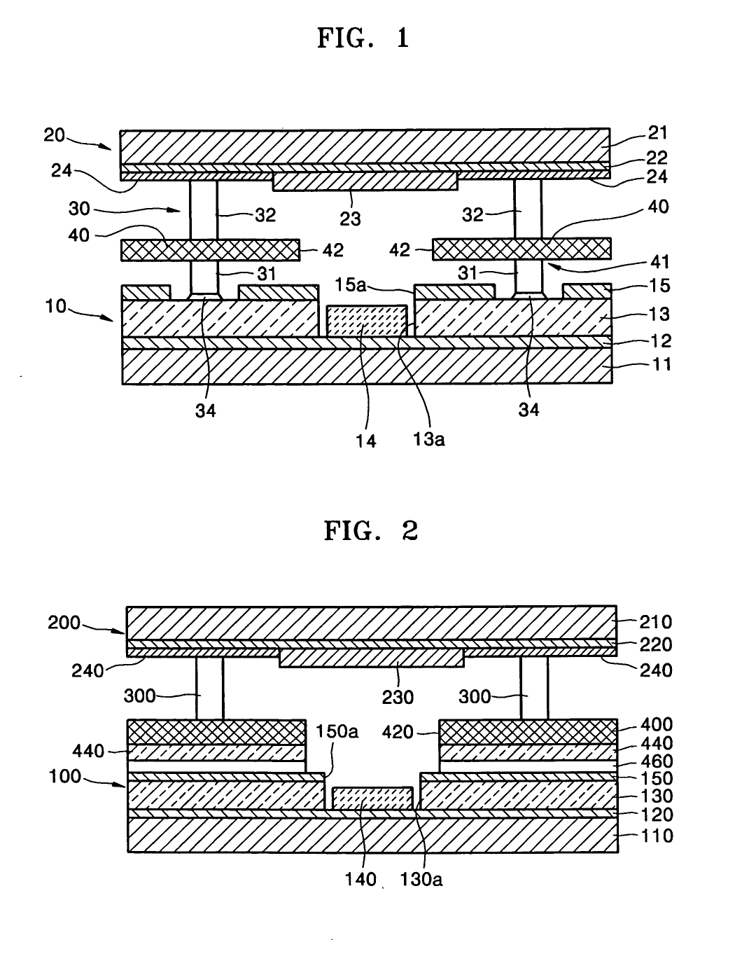

FIG. 1 is a sectional view of an example of an FED having a mesh grid employed as a second gate electrode.

A cathode plate 10 and an anode plate 20 are separated from each other by a spacer 30. A space between the cathode plate 10 and the anode plate 20 is under vacuum and thus the cathode plate 10 and the anode plate 20 are firmly held together by an internal negative pressure with a lower spacer 31 and an upper spacer 32 interposed therebetween.

In the cathode plate 10, a cathode electrode 12 is formed on a rear panel 11 and a gate insulation layer 13 is formed on the cathode electrode 12. A thru-hole 13a is formed in the gate insulation layer 13 and the cathode electrode 12 is exposed via the thru-hole 13a. An electron emission source 14, such as Carbon Nano-Tubes (CNTs), is formed on the cathode electrode 12 exposed via the thru-hole 13a. A gate electrode 15 is formed on the gate insulation layer 13. The gate electrode 15 has a gate hole 15a corresponding to the thru-hole 13a.

In the anode plate 20, an anode electrode 22 is formed inside of a front panel 21. A fluorescent layer 23 is formed on a portion of the anode electrode 22 facing the gate hole 15a. A black matrix 24 can be formed on the rest of the anode electrode 22.

A mesh grid 40 is provided between the cathode plate 10 and the anode plate 20, the mesh grid 40 being separated from the cathode plate 10 and the anode plate 20 and supported by the lower spacer 31 and the upper spacer 32. The mesh grid 40 has an electron beam control hole 42 corresponding to the gate hole 15a.

In such an FED, a method of combining a spacer is as follows.

First, an insulation layer (the lower spacer 31) is formed on one side of the mesh grid 40, a frit paste 34 is printed on the insulation layer 31, and a portion of the insulation layer 31 covered with the frit paste 34 is arranged to contact the gate insulation layer 13. Subsequently, the frit paste 34 is sintered at a temperature of 430° C. for a predetermined period of time, e.g., 20 minutes.

The anode plate 20 with the upper spacer 32 attached in a typical manner is aligned with the cathode plate 10 having the mesh grid 40 thereon, and then vacuum-packaged.

According to this method, firing of the frit paste 34 at a high temperature of about 430° C. takes about 4 to 8 hours including a temperature rising time and cooling time, and a difference in thermal expansion between the metal mesh grid 40 and the cathode plate 10 may cause a misalignment therebetween. In addition, a high temperature may create a deformation of the mesh grid 40. Furthermore, a deterioration of the exposed electron emission source 14 can impair an electron emission effect.

Lastly, the frit paste 34 can flow into a lateral side of the electron beam control hole 42 of the mesh grid 40, whereby arcing may occur in driving the FED.

The deformation of the mesh grid results in a deterioration of the performance of the FED. Therefore, a new method to overcome this problem is required.

Exemplary embodiments according to the present invention are described in detail below with reference to the accompanying drawings. Thicknesses of layers or regions shown in the drawings have been exaggerated for clarity.

FIG. 2 is a sectional view of an FED according to an embodiment of the present invention.

A cathode plate 100 and an anode plate 200 are separated from each other by a spacer 300. A space between the cathode plate 100 and the anode plate 200 is under vacuum and thus the cathode plate 100 and the anode plate 200 are firmly held together by an internal negative pressure with a spacer 300.

In the cathode plate 100, a cathode electrode 120 is formed on a rear panel 110, and a gate insulation layer 130 is formed on the cathode electrode 120. A thru-hole 130a is formed in the gate insulation layer 130. An electron emission source 140, such as Carbon Nano-Tubes (CNTs), is formed on the cathode electrode 120 exposed via the thru-hole 130a. A gate electrode 150 is formed on the gate insulation layer 130. The gate electrode 150 has a gate hole 150a corresponding to the thru-hole 130a. The gate electrode 150 and the cathode electrode 120 are typically arranged in a stripe shape and placed at right angles. The gate electrode 150 is formed of Cr with a thickness of about 0.25 μm.

In the anode plate 200, an anode electrode 220 is formed inside of a front panel 210. A fluorescent layer 230 is formed on a portion of the anode electrode 220 facing the gate hole 150a. A black matrix 240 for blocking absorption of external light and preventing optical crosstalk is formed on the rest of the anode electrode 220.

A mesh grid 400 is provided between the cathode plate 100 and the anode plate 200. The mesh grid 400 is separated from the cathode plate 100 and the anode plate 200 by an insulation layer 440 and an adhesion layer 460 the mesh grid 400 which are provided below the mesh grid 400, and the spacer 300 which is provided above.

The insulation layer 440 below the mesh grid 400 can be formed of SiO₂. The adhesion layer 460 below the insulation layer 440 can be formed of a photosensitive polyimide. This polyimide is cured at low temperatures of about 150˜300° C.

The mesh grid 400 has an electron beam control hole 420 corresponding to the gate hole 150a.

Accordingly, in an FED according to an embodiment of the present invention, it is possible to prevent a deformation and a misalignment due to high-temperature firing since a heating process for combining the mesh grid 400 formed of a metal plate with the cathode plate 100 is implemented at low temperatures for a short time.

An embodiment of a method of manufacturing a FED according to an embodiment of the present invention is described below in detail.

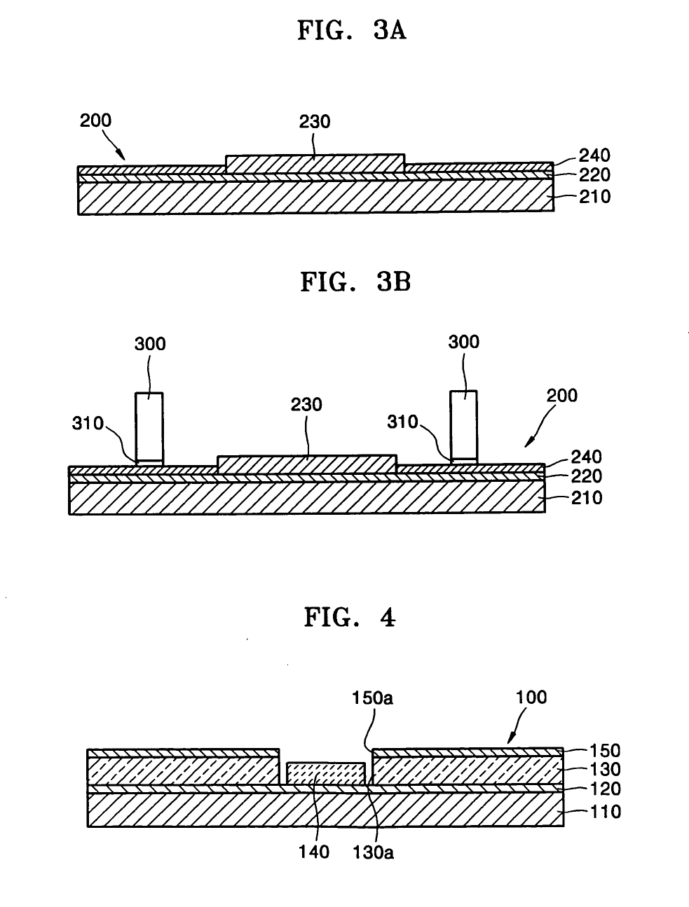

FIGS. 3A and 3B are sectional views of a method of manufacturing an anode plate.

The anode plate 200 is located where the anode electrode 220, the fluorescent layer 230, and the black matrix 240 are formed inside (upper side of the drawing) of the front panel 210.

The spacer 300 is located with the anode plate 200 and attached to the black matrix 240. A binder 310 formed of a paste is used to attach the spacer 300. The fluorescent layer 230 is fired and the binder 310 is hardened by heating the anode plate 200 with the spacer 300 attached.

FIG. 4 is a sectional view of a method of manufacturing a cathode plate.

The cathode plate 100 is located where the cathode electrode 120, the gate insulation layer 130, the gate electrode 150, and the electron emission source 140 are formed inside (upper side of the drawing) of the rear panel 110. The gate insulation layer 130 and the gate electrode 150 are stacked on the cathode electrode 120 and respectively have the thru-hole 130a and the gate hole 150a corresponding to the fluorescent layer 230. The electron emission source 140 emits electrons on the cathode electrode 120 exposed via the gate hole 150a.

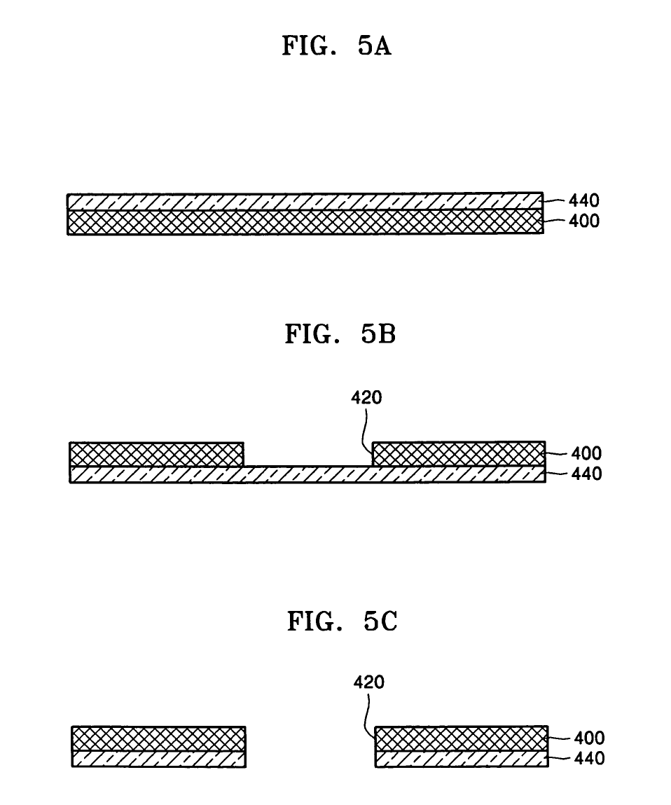

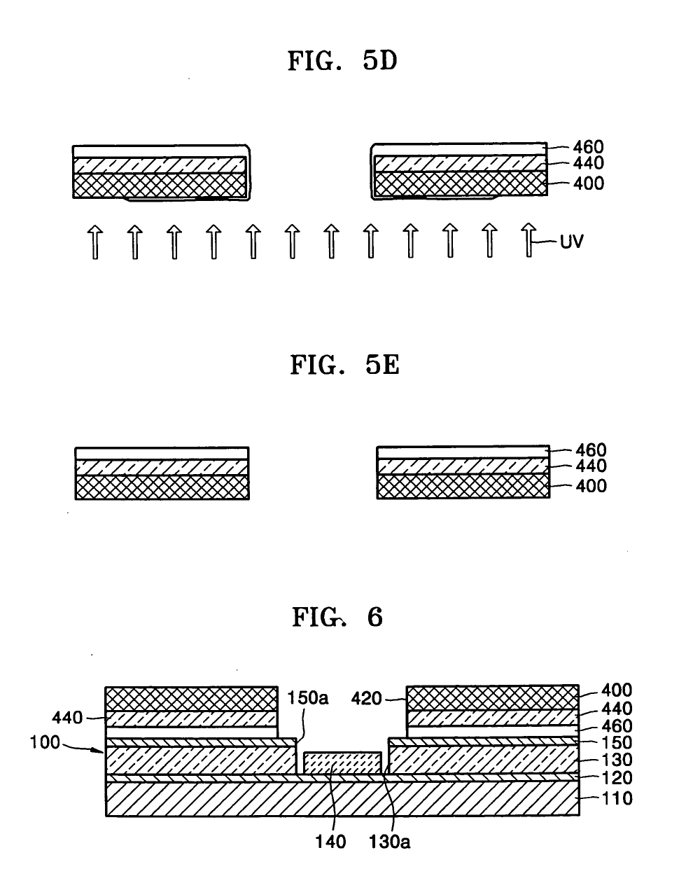

FIGS. 5A to 5E are diagrams of a method of providing a mesh grid according to an embodiment of the present invention.

As shown in FIG. 5A, the insulation layer 440, e.g., SiO₂ paste, is printed on one side of Invar with thicknesses of about 50˜100 μm by squeezing. The insulation layer 440 is fired at temperatures of about 460˜500° C.

As shown in FIG. 5B, the electron beam control hole 420 is formed in the Invar by a photolithography process. In this case, a photoresist mask is used. The photoresist mask has a window corresponding to the electron beam control hole 420, and FeCl3 can be used as an etchant.

As shown in FIG. 5C, the electron beam control hole 420 is completely penetrated by etching the insulation layer 440 using the Invar, which has the electron beam control hole 420, as a mask. In this case, HF can be used as an etchant.

As shown in FIG. 5D, a photosensitive adhesive, e.g., a photosensitive polyimide 460 or a photosensitive epoxy resin, is formed on the insulation layer 440 by a spin coating method, a screen printing method, or a roller printing method, and then soft-baked. The polyimide 460 can be coated on a lateral side of the electron beam control hole 420 or on a lower side of the mesh grid 400.

Subsequently, when the polyimide is exposed to ultraviolet light rays using the mesh grid 400 as a mask and then developed, the polyimide coated on the lateral side of the electron beam control hole 420 and the lower side of the mesh grid 400 is removed (refer to FIG. 5E).

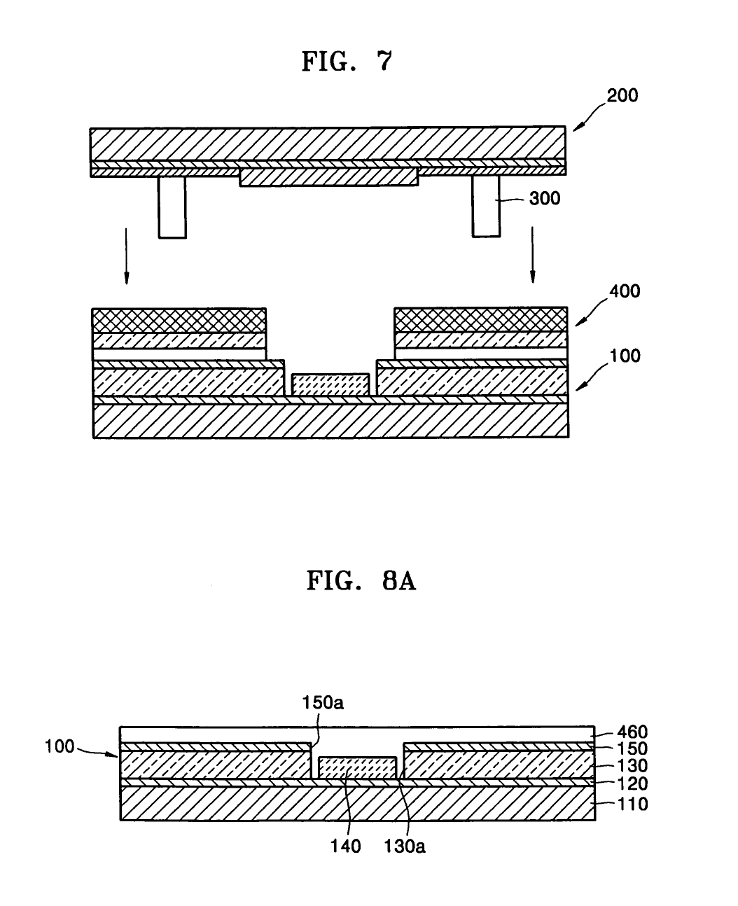

FIGS. 6 and 7 are diagrams of a procedure of combining a cathode plate, a mesh grid, and an anode plate which are separately fabricated.

The mesh grid 400 is aligned inside of the cathode plate 100, and attached to the cathode plate 100 by curing at temperatures of about 150˜300° C. for 10 minutes.

A desired FED is obtained by combining and sealing the cathode plate 100 and the anode plate 200

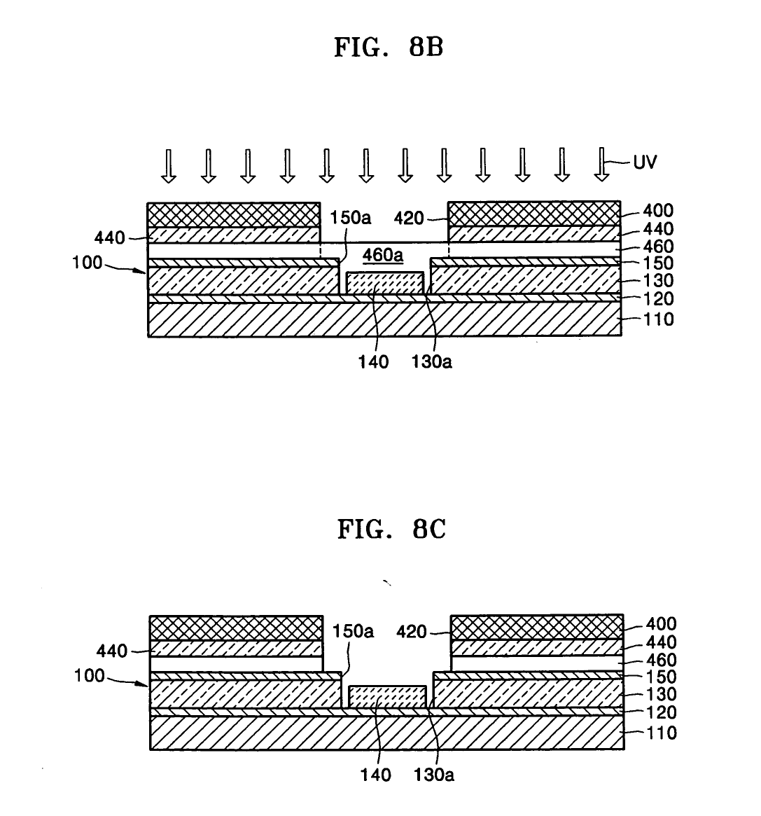

FIGS. 8A to 8C are diagrams of a procedure of attaching a mesh grid to a cathode plate according to another embodiment of the present invention. The same components are denoted by the same reference numerals, and a detailed description thereof has been omitted.

Referring to FIG. 8A, the photosensitive polyimide layer 460 covering the electron emission source 140 and the cathode electrode 150 is formed on the cathode plate 100 by a spin coating method, a screen printing method, or a roller printing method, and then soft-baked.

As shown in FIG. 8B, the mesh grid 400 prepared in advance (refer to FIG. 5C) is aligned with the cathode plate 100. Subsequently, the polyimide layer 460 is exposed to ultraviolet light rays using the mesh grid 400 as a mask. Reference numeral 460a indicates an exposed portion. The exposed portion 460a is then developed.

FIG. 8C shows a resultant object after the development. When the resultant object is cured at temperatures of 150˜300° C. for 10 minutes, the mesh grid 400 is fixed to the cathode plate 100.

A method of combining and sealing the anode plate 200 and the cathode plate 100 is the same as that described above, and a detailed description thereof has been omitted.

While the aforementioned embodiment has illustrated that a mesh grid with an insulation layer formed below is aligned on a polyimide layer, the mesh grid without the insulation layer can be directly attached to the polyimide layer. If so, the thickness of the polyimide layer increases to about 20˜50 μm.

In addition, while the polyimide layer is soft-baked before the mesh grid is aligned in the aforementioned embodiment, the polyimide layer can be soft-baked after the mesh grid is aligned. When the soft baking is performed after aligning of the mesh grid, the mesh grid can be firmly attached to the polyimide layer.

According to the present invention, it is possible to minimize a misalignment between a mesh grid and a cathode plate since a heat treatment process can be performed at low temperatures by using a polyimide in attaching the mesh grid to the cathode plate. In addition, a deterioration of the CNTs, that is, the electron emission source, can be prevented during the attaching process. Therefore, a method of manufacturing such an FED is suitable for manufacturing a large-sized FED.

While the present invention has been described with reference to exemplary embodiments thereof, it will be understood by those skilled in the art that various modifications in form and detail can be made therein without departing from the scope of the present invention as defined by the following claims.

1. A Field Emission Display (FED) comprising:
an anode plate having an anode electrode and a fluorescent layer arranged therein;
a cathode plate having an electron emission source and a gate electrode arranged therein, the electron emission source facing the fluorescent layer and adapted to emit electrons and the gate electrode having a gate hole adapted to pass the electrons therethrough;
a mesh grid arranged within the cathode plate, the mesh grid having an electron beam control hole corresponding to the gate hole and having a photosensitive adhesion layer on a surface facing the cathode plate; and
a spacer provided between the anode plate and the mesh grid and adapted to closely adhere the mesh grid to the cathode plate by a negative pressure between the anode plate and the cathode plate.

2. The FED of claim 1, wherein the mesh grid further comprises an insulation layer arranged between the surface facing the cathode plate and the photosensitive adhesion layer.

3. The FED of claim 1, wherein the photosensitive adhesion layer comprises a photosensitive polyimide layer.

4. The FED of claim 2, wherein the photosensitive adhesion layer comprises a photosensitive polyimide layer.

5. A method of manufacturing a Field Emission Display (FED), the method comprising:
forming an anode plate having an anode electrode and a fluorescent layer arranged therein;
forming a cathode plate having an electron emission source and a gate electrode arranged therein, the electron emission source facing the fluorescent layer and adapted to emit electrons and the gate electrode having a gate hole adapted to pass the electrons therethrough;
forming an additional mesh grid having an electron beam control hole corresponding to the gate hole and having an insulation layer and an adhesion layer sequentially stacked on a first surface facing the cathode plate;
combining the mesh grid and the cathode plate so that the adhesion layer of the mesh grid faces the cathode plate; and
combining and vacuum-sealing the anode plate and the cathode plate with a spacer interposed between the cathode plate and the anode plate.

6. The method of claim 5, wherein the insulation layer of the mesh grid comprises SiO₂.

7. The method of claim 5, wherein forming the mesh grid comprises:
forming a metal plate having an electron beam control hole therein;
forming an insulation layer having a hole corresponding to the electron beam control hole;
forming a photosensitive adhesion layer on the insulation layer;
exposing the photosensitive adhesion layer from a second surface of the metal plate; and
removing the exposed photosensitive adhesion layer.

8. The method of claim 7, wherein the photosensitive adhesion layer comprises a photosensitive polyimide.

9. The method of claim 6, wherein the photosensitive adhesion layer is formed by a method selected from the group consisting of a spin coating method, a screen printing method, and a roller printing method.

10. The method of claim 5, wherein combining and vacuum-sealing comprises curing at a temperature of 150˜300° C.

11. A method of manufacturing a Field Emission Display (FED), the method comprising:
forming an anode plate having an anode electrode and a fluorescent layer arranged therein;
forming a cathode plate having an electron emission source and a gate electrode arranged therein, the electron emission source facing the fluorescent layer and adapted to emit electrons and the gate electrode having a gate hole adapted to pass the electrons therethrough;
forming an additional mesh grid having an electron beam control hole corresponding to the gate hole;
forming a photosensitive adhesion layer covering the gate electrode on the cathode plate;
arranging the mesh grid on the adhesion layer;
exposing the adhesion layer from above the cathode plate;
removing the exposed adhesion layer; and
combining and vacuum-sealing the anode plate and the cathode plate with a spacer interposed between the cathode plate and the anode plate.

12. The method of claim 11, wherein the photosensitive adhesion layer comprises a photosensitive polyimide.

13. The method of claim 12, wherein the photosensitive adhesion layer is formed by a method selected from the group consisting of a spin coating method, a screen printing method, and a roller printing method.

14. The method of claim 11, wherein forming the additional mesh grid comprises forming an insulation layer having a hole corresponding to the electron beam control hole on one side of the mesh grid; and wherein arranging the mesh grid comprises contacting the insulation layer on the mesh grid with the adhesion layer.

15. The method of claim 11, wherein forming the photosensitive adhesion layer comprises soft-baking the adhesion layer.

16. The method of claim 11, wherein arranging the mesh grid comprises soft-baking the adhesion layer.

17. The method of claim 11, wherein combining and vacuum-sealing the anode plate and the cathode plate comprises curing at a temperature of 150˜300° C.
